(19) United States
(12) Patent Application Publication
(10) Pub. No.: US 2022/0376338 A1
(43) Pub. Date: Nov. 24, 2022

(54) SHEET METAL ASSEMBLY HAVING ONE STIFFENING MEMBERS WITH A PREDETERMINED DRAW DEPTH

(71) Applicant: GM Global Technology Operations LLC, Detroit, MI (US)

(72) Inventors: Andrew Clay Bobel, Troy, MI (US); Louis G. Hector, JR., Shelby Twp, MI (US); Erik Brandon Golm, Warren, MI (US); Anil K. Sachdev, Rochester Hills, MI (US); Charles E. Jensen, Shelby Twp, MI (US)

(21) Appl. No.: 17/323,041

(22) Filed: May 18, 2021

(51) Int. Cl. H01M 50/224; H01M 50/249; H01M 50/233; C22F 1/04; B21D 22/02

(52) U.S. Cl. CPC H01M 50/224; H01M 50/249; H01M 50/233; C22F 1/04; B21D 22/02; H01M 2220/20

(57) ABSTRACT

A sheet metal assembly includes a drawn metal sheet constructed of a metal material. The drawn metal sheet defines a surface and includes one or more stiffening features disposed along the drawn metal sheet. The one or more stiffening features represents a raised area disposed along the surface of the drawn metal sheet. Each of the one or more stiffening features include a predefined draw depth ranging from about twenty millimeters to about eighty millimeters.

### INTRODUCTION

The present disclosure relates to a sheet metal assembly. More particularly, the present disclosure relates to a sheet metal assembly including a drawn metal sheet including one or more stiffening members, where the stiffening members have a predetermined draw depth. The present disclosure is also directed towards a metal forming process for creating the drawn sheet assembly.

In a hybrid or electric vehicle, at least a portion of the motive power is provided by one or more rechargeable battery packs that act as a direct current (DC) voltage source to a motor, generator, or transmission, which in turn may be used to provide the energy needed to rotate the vehicle's wheels. The rechargeable battery packs each include a series of individual batteries. A rechargeable energy storage systems (RESS) refers to a system including the rechargeable battery packs as well as the various ancillary subsystems for thermal management, electronic control, support, and enclosure. One such component of the RESS is a battery tray, which is used to secure the batteries.

Current battery trays may be constructed of plain-carbon ferritic steels with strengths of about 300 Megapascals. The battery tray constructed from this plain-carbon steel may require numerous reinforcements and stiffening features to provide the required structural performance. However, the reinforcements require dedicated packaging space that could otherwise be used to house batteries. Also, the reinforcements and stiffening features may complicate the assembly process and also incur additional costs. Furthermore, the battery tray may also undergo an electrocoat paint operation (ELPO) in order to introduce a protective coating. However, it is to be appreciated that the protective coating may be scratched, and therefore the battery tray will need to be repaired where the scratching occurred, or else corrosion may occur.

Thus, while current battery trays achieve their intended purpose, there is a need in the art for a battery tray having a relatively simple, lightweight design that has fewer packaging constraints.

### SUMMARY

According to several aspects, a sheet metal assembly is disclosed, and includes a drawn metal sheet constructed of a metal material, where the drawn metal sheet defines a surface. The drawn metal sheet includes one or more stiffening features disposed along the drawn metal sheet. The one or more stiffening features represents a raised area disposed along the surface of the drawn metal sheet, and each of the one or more stiffening features include a predefined draw depth ranging from about twenty millimeters to about eighty millimeters.

In one aspect, the one or more stiffening features include one or more crossbars.

In another aspect, the one or more crossbars extend in a lengthwise direction across the drawn metal sheet.

In yet another aspect, the one or more crossbars are disposed along substantially an entire length of the drawn metal sheet.

In still another aspect, each crossbar of the one or more crossbars includes a series of individual bars.

In one aspect, the series of individual bars are disposed along substantially an entire length of the drawn metal sheet.

In another aspect, each crossbar includes a single individual member.

In yet another aspect, the one or more crossbars each define a crossbar width, and wherein the one or more crossbars are spaced at least six times the crossbar width from one another.

In still another aspect, the one or more crossbars each define a crossbar width, and the one or more crossbars are spaced no more than sixteen times the crossbar width from one another.

In an aspect, the sheet metal assembly further comprises a plurality of reinforcement members, where each reinforcement member of the plurality of reinforcement members is joined to an upper surface of a corresponding crossbar.

In another aspect, the plurality of reinforcement members are constructed of a material identical to the metal material of the drawn metal sheet.

In yet another aspect, the metal material is steel including a predetermined yield strength of at least about 500 Megapascals.

In still another aspect, the metal material is an aluminum alloy having a predetermined yield strength of at least about 300 Megapascals.

In one aspect, the sheet metal assembly is a battery tray that is part of a rechargeable energy storage system (RESS) for a vehicle.

In one aspect, a method of creating a sheet metal assembly including a drawn metal sheet is disclosed. The method includes providing a blank, where the blank is constructed of a metal material. The method also includes stamping the blank into the drawn metal sheet by forming one or more stiffening features along a surface of the drawn metal sheet. The one or more stiffening features represents a raised area disposed along the surface of the drawn metal sheet, and each of the one or more stiffening features include a predefined draw depth ranging from about twenty millimeters to about eighty millimeters.

In one aspect, the method further comprises prior to stamping the blank, heating the blank to a predetermined temperature.

In another aspect, the predetermined temperature ranges from about thirty percent to about eighty percent of a melt temperature for steel and from about thirty percent to about eighty five percent of a melt temperature of an aluminum alloy.

In yet another aspect, the blank is heated while being formed.

In still another aspect, the method further comprises annealing the drawn metal sheet after forming.

In one aspect, the one or more stiffening features include one or more crossbars, and the method further comprises joining a reinforcement member to an upper surface of a corresponding crossbar.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of one embodiment of the disclosed sheet metal assembly according to an exemplary embodiment;

FIG. 2 is an elevated perspective view of a drawn metal sheet that is part of the sheet metal assembly shown in FIG. 1 according to an exemplary embodiment;

FIG. 3 is an enlarged view of one of the crossbars of the drawn metal sheet shown in FIG. 2 according to an exemplary embodiment;

FIG. 4 is an enlarged view of an alternative embodiment the crossbar shown in FIG. 3 according to an exemplary embodiment;

FIG. 5 is a cross-sectioned view of the drawn metal sheet shown in FIG. 2 taken along section line A-A according to an exemplary embodiment;

FIG. 6 is an enlarged view of one of the crossbars shown in FIG. 1 including a corresponding reinforcement member and a corresponding cover according to an exemplary embodiment; and

FIG. 7 is a process flow diagram illustrating a method of creating the sheet metal assembly according to an exemplary embodiment.

### DETAILED DESCRIPTION

The following description is merely exemplary in nature and is not intended to limit the present disclosure, application, or uses.

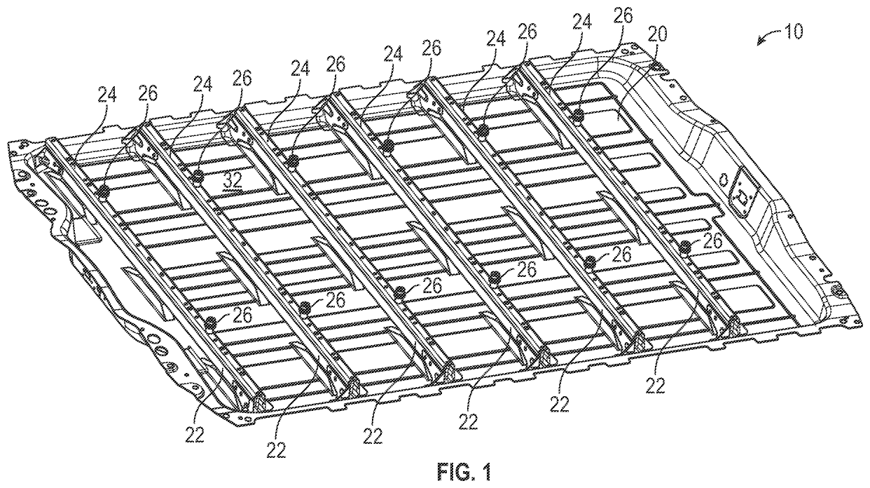

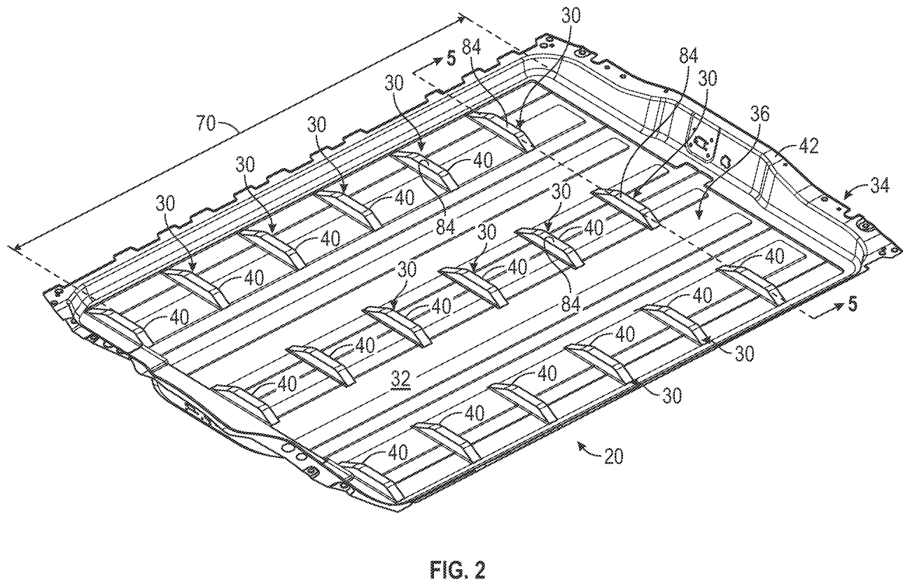

Referring to FIG. 1, an exemplary sheet metal assembly 10 is illustrated. In the non-limiting embodiment as shown, the sheet metal assembly 10 includes a drawn metal sheet 20, a plurality of reinforcement members 22, and a plurality of covers 24. In an embodiment, each of the plurality of covers 24 are secured to a corresponding one of the reinforcement members 22 by one or more mechanical fasteners 26. In the non-limiting embodiment as shown in FIG. 1, the sheet metal assembly 10 is a battery tray that is part of a rechargeable energy storage system (RESS) for a vehicle. However, it is to be appreciated that FIG. 1 is merely exemplary in nature. It is also to be appreciated that the sheet metal assembly 10 is not limited to a specific component or application and may be used in a variety of other applications as well. As explained below, the drawn metal sheet 20 includes one or more integrated stiffening features 30 (illustrated in FIG. 2 as crossbars 40) that enhance the stiffness of the drawn metal sheet 20, which in turn reduces the overall complexity of the sheet metal assembly 10 and also simplifies the assembly process.

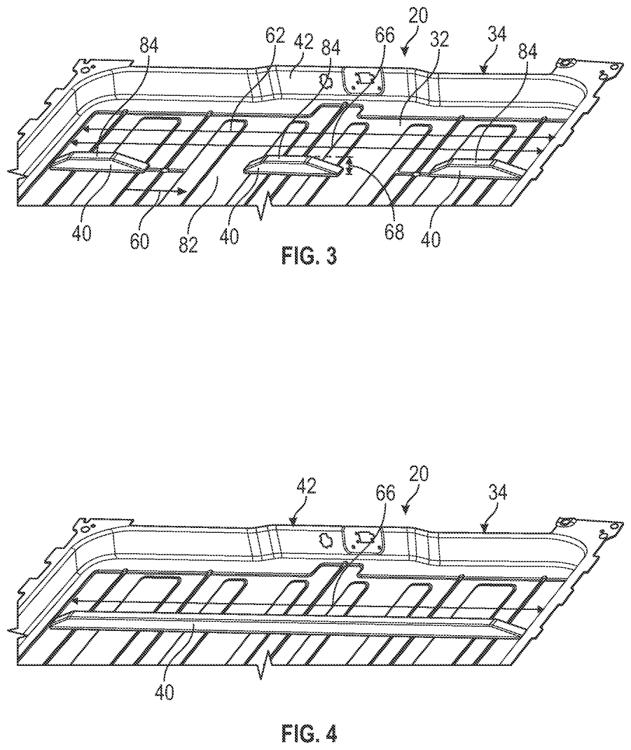

FIG. 2 is an elevated perspective view of the drawn metal sheet 20 shown in FIG. 1, where the plurality of reinforcement members 22 and the plurality of covers 24 have been removed in order to reveal the one or more integrated stiffening features 30. The drawn metal sheet 20 defines a surface 32, an outer periphery 34, and a main body 36, where the outer periphery 34 surrounds the main body 36 of the drawn metal sheet 20. In the embodiment as shown in FIG. 2, a raised ledge 42 is disposed around an entire outer periphery 34 of the drawn metal sheet 20, and the main body 36 includes a substantially planar or flattened profile. It is to be appreciated that the main body 36 represents a portion of the drawn metal sheet 20 where a surface area has been extended when compared to the original sheet blank that was used to create the drawn metal sheet 20. The one or more stiffening features 30 are disposed along the surface 32 of the main body 36 of the drawn metal sheet 20. The one or more integrated stiffening features 30 represent a raised area disposed along the surface 32 of the drawn metal sheet 20, where the raised area increases an overall stiffness of the drawn metal sheet 20. In the example as shown in FIG. 2, the one or more integrated stiffening features 30 are crossbars 40. Although FIGS. 2-3 illustrate the integrated stiffening features 30 as crossbars 40, it is to be appreciated that the figures are merely exemplary in nature and other stiffening features may be used as well.

The crossbars 40 each represent a raised area disposed along the surface 32 of the drawn metal sheet 20, where each crossbar 40 includes an elongated profile. FIG. 3 is an enlarged view of one of the crossbars 40 shown in FIG. 2. In the embodiment as shown in FIGS. 2 and 3, each crossbar 40 is comprised of a series of individual bars that are aligned with one another in a lengthwise direction 60 along the surface 32 of the drawn metal sheet 20. In the alternative embodiment as shown in FIG. 4, the crossbar 40 is a single, individual member that extends in the lengthwise direction 60 across the metal sheet 20.

Referring back to FIGS. 2 and 3, the individual bars of the crossbar 40 are disposed along substantially an entire length 62 of the drawn metal sheet 20. In the embodiment as shown in the figures, substantially the entire length 62 of the drawn metal sheet 20 excludes the outer periphery 34 and the raised ledge 42 that is disposed along the outer periphery 34 of the drawn metal sheet 20. The crossbar 40 defines a crossbar length 66 that includes each of the individual bars, as well as a crossbar width 68. In an embodiment, the crossbar length 66 is at least twice the crossbar width 68.

Referring to both FIGS. 2 and 3, in one embodiment the one or more crossbars 40 are spaced at least six times the crossbar width 68 from one another, and in an embodiment the one or more crossbars 40 are spaced no more than sixteen times the crossbar width 68 from one another. In the embodiment as shown in FIG. 2, six crossbars 40 extend along a width 70 of the drawn metal sheet 20, however, it is to be appreciated FIG. 2 is merely exemplary in nature and the total number of crossbars 40 depend upon the width 70 of the drawn metal sheet 20. In other words, the total number of crossbars 40 depend upon packaging space.

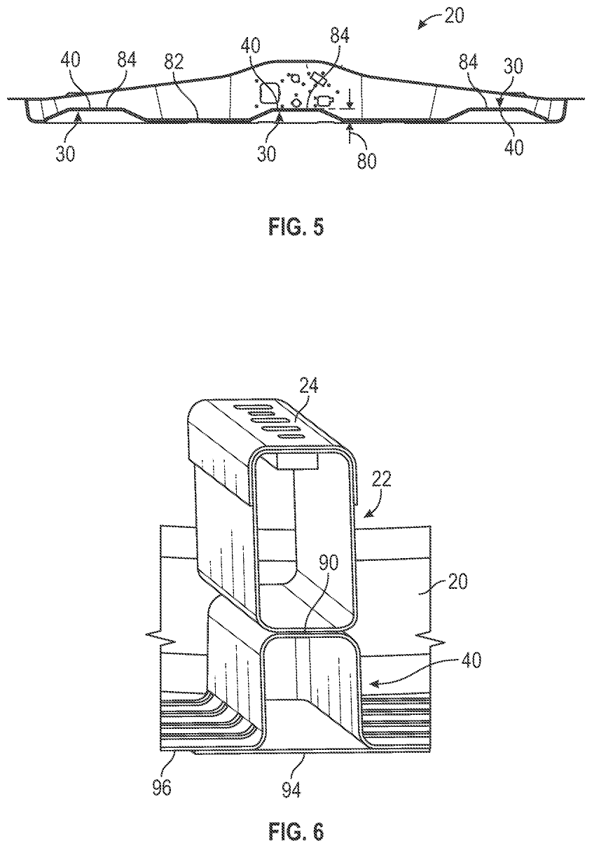

FIG. 5 is a cross-sectioned view of the drawn metal sheet 20 taken along section line A-A, as seen in FIG. 2. Referring to both FIGS. 2 and 5, each of the one or more stiffening features 30 (i.e., the crossbar 40) include a predefined draw depth 80 ranging from about twenty millimeters to about eighty millimeters. In one embodiment, the predefined draw depth 80 ranges from about twenty millimeters to about sixty millimeters. In another embodiment, the predefined draw depth 80 ranges from about thirty millimeters to about forty millimeters. As seen in FIG. 5, the draw depth 80 of the one or more stiffening features 30 is measured between a floor 82 of the drawn metal sheet 20 and an uppermost surface 84 of the one or more stiffening features 30. The predefined draw depth 80 is based on several factors, which include but are not limited to, a thickness of a metal material that the drawn metal sheet 20 is constructed of, the material properties of the metal material, and the formability, which is a function of ductility, fracture toughness, and anisotropy.

Referring back to FIG. 2, the drawn metal sheet 20 is constructed of a metal material having a predetermined yield strength. In an embodiment, the metal material is steel, and includes a predetermined yield strength of at least about 500 Megapascals. However, in one embodiment, the predetermined yield strength of the steel may be as high as 1200 Megapascals. Some examples of steels that may be used include, but are not limited to, dual-phase steels, quenched and partitioned steels, multi-phase steels, medium-carbon-steels, stainless steels, transformation induced plastic steels, precipitation-hardened steels, press-hardened steels, and similar steels displaying high strength. Although steel is discussed, it is to be appreciated that the metal material is not limited to steel. For example, in another embodiment, the metal material is an aluminum alloy having a predetermined yield strength of at least about 300 Megapascals. Some examples of aluminum alloys that may be used include, but re not limited to, high strength precipitation hardened 6000 and 7000 series aluminum alloys. Although steel and aluminum alloys are described, it is to be appreciated that other metal materials may be used as well. For example, in still another embodiment, the metal material may be a magnesium alloy or a titanium alloy.

FIG. 6 is an enlarged view of one of the crossbars 40 shown in FIG. 1 including a corresponding reinforcement member 22 and a corresponding cover 24. Referring to both FIGS. 1 and 6, each reinforcement member 22 is joined to an upper surface 90 of a corresponding crossbar 40. It is to be appreciated that any number of joining methods may be used to attach the reinforcement member 22 to the crossbar 40 such as, but not limited to, laser welding, arc welding, mechanical fasteners, and adhesives. Furthermore, since the crossbar 40 is integral to or is part of the drawn metal sheet 20, fewer components may be required. In an embodiment, the reinforcement members 22 are constructed of a material identical to the metal material of the drawn metal sheet 20. However, in another embodiment, the reinforcement members 22 are constructed of a different material that is similar in strength to the metal material of the drawn metal sheet 20. In the embodiment as shown in FIG. 6, the sheet metal assembly 10 further includes a sealing panel 94. The sealing panel 94 is disposed along a lower surface 96 of the drawn metal sheet 20 and is used to prevent the ingression of debris. In the embodiment as shown in FIG. 6, the lower surface 96 is the surface that faces the pavement when the battery tray is in install in a vehicle.

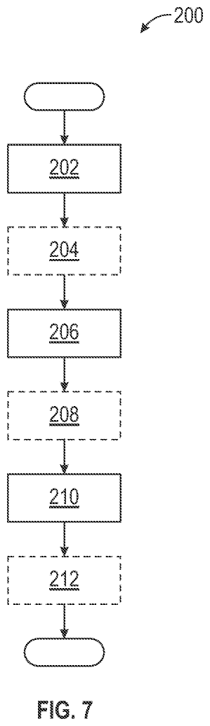

A method of creating the drawn metal sheet 20 of the sheet metal assembly 10 as shown in FIG. 1 is now described. FIG. 7 is a process flow diagram illustrating an exemplary method 200 for forming the drawn metal sheet 20. Referring now to FIGS. 1 and 8, the method 200 begins at block 202. In block 202, a blank constructed of the metal material of the drawn metal sheet 20 is provided. The method 200 may then proceed to block 204.

In block 204, the blank is heated to a predetermined temperature. It is to be appreciated that block 204 is optional and may be omitted in some embodiments, and therefore is shown in phantom line. The predetermined temperature is based on the metal material that the drawn metal sheet 20 is constructed of. In an embodiment, the predetermined temperature ranges from about thirty percent to about eighty percent of a melt temperature for steel and from about thirty percent to about eighty five percent of a melt temperature of an aluminum alloy. For example, if the metal material is steel, the predetermined melt temperature may range from about 450 to about 1000 degrees Celsius. In another embodiment, if the metal material is an aluminum alloy, then the predetermined melt temperature may range from about 200 to about 550 degrees Celsius. The method may then proceed to block 206.

In block 206, the blank is placed in a die and is stamped into the drawn metal sheet 20 by forming one or more stiffening features 30 (FIG. 2) along the surface 32 of the drawn metal sheet 20. In an embodiment, if the blank is heated in block 202, then the die is unheated, and the blank is quenched within the die while being stamped. In an embodiment where the blank is not heated, then the die may heat the blank in regions where the one or more stiffening features 30 are stamped. The method 200 may then proceed to block 208.

In block 208, the drawn metal sheet 20 is annealed after forming. It is to be appreciated that block 208 is optional and may be omitted in some embodiments. The method 200 may then proceed to block 210.

In block 210, the reinforcement member 22 (seen in FIGS. 2 and 6) is joined to the upper surface 90 of a corresponding crossbar 40. It is to be appreciated that any number of joining approaches may be used such as, for example, laser welding, arc welding, adhesive, or mechanical fasteners. The method 200 may then proceed to block 212.

In block 212, the sheet metal assembly 10 shown in FIG. 1 undergoes electrocoat paint operation (ELPO). It is to be appreciated that block 212 is optional and may be omitted in some embodiments. Specifically, if the drawn metal sheet 20 is constructed of a stainless steel or a titanium alloy, then block 212 may be omitted. The method 200 may then terminate.

Referring generally to the figures, the disclosed sheet metal assembly includes various technical effects and benefits. Specifically, the disclosed drawn metal sheet includes integrated stiffening features and reinforcements, which in turn reduce complexity of the overall assembly and also simplify the assembly process. In the event the drawn metal sheet is constructed of stainless steel, then an ELPO may also be omitted as well, which in turn further simplifies the assembly process. Furthermore, the disclosed sheet metal assembly may result in significant weight savings as well as packaging enhancements, since additional reinforcements may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A sheet metal assembly, comprising:
a drawn metal sheet constructed of a metal material, wherein the drawn metal sheet defines a surface, and wherein the drawn metal sheet comprises:
one or more stiffening features disposed along the drawn metal sheet, wherein the one or more stiffening features represents a raised area disposed along the surface of the drawn metal sheet, and wherein each of the one or more stiffening features include a predefined draw depth ranging from about twenty millimeters to about eighty millimeters.

2. The sheet metal assembly of claim 1, wherein the one or more stiffening features include one or more crossbars.

3. The sheet metal assembly of claim 2, wherein the one or more crossbars extend in a lengthwise direction across the drawn metal sheet.

4. The sheet metal assembly of claim 3, wherein the one or more crossbars are disposed along substantially an entire length of the drawn metal sheet.

5. The sheet metal assembly of claim 2, wherein each crossbar of the one or more crossbars includes a series of individual bars.

6. The sheet metal assembly of claim 5, wherein the series of individual bars are disposed along substantially an entire length of the drawn metal sheet.

7. The sheet metal assembly of claim 2, wherein each crossbar includes a single individual member.

8. The sheet metal assembly of claim 2, wherein the one or more crossbars each define a crossbar width, and wherein the one or more crossbars are spaced at least six times the crossbar width from one another.

9. The sheet metal assembly of claim 2, wherein the one or more crossbars each define a crossbar width, and wherein the one or more crossbars are spaced no more than sixteen times the crossbar width from one another.

10. The sheet metal assembly of claim 2, further comprising a plurality of reinforcement members, wherein each reinforcement member of the plurality of reinforcement members is joined to an upper surface of a corresponding crossbar.

11. The sheet metal assembly of claim 10, wherein the plurality of reinforcement members are constructed of a material identical to the metal material of the drawn metal sheet.

12. The sheet metal assembly of claim 1, wherein the metal material is steel including a predetermined yield strength of at least about 500 Megapascals.

13. The sheet metal assembly of claim 12, wherein the metal material is an aluminum alloy having a predetermined yield strength of at least about 300 Megapascals.

14. The sheet metal assembly of claim 1, wherein the sheet metal assembly is a battery tray that is part of a rechargeable energy storage system (RESS) for a vehicle.

15. A method of creating a sheet metal assembly including a drawn metal sheet, wherein the method comprises:
providing a blank, wherein the blank is constructed of a metal material; and
stamping the blank into the drawn metal sheet by forming one or more stiffening features along a surface of the drawn metal sheet, wherein the one or more stiffening features represents a raised area disposed along the surface of the drawn metal sheet, and wherein each of the one or more stiffening features include a predefined draw depth ranging from about twenty millimeters to about eighty millimeters.

16. The method of claim 15, wherein the method further comprises:
prior to stamping the blank, heating the blank to a predetermined temperature.

17. The method of claim 16, wherein the predetermined temperature ranges from about thirty percent to about eighty percent of a melt temperature for steel and from about thirty percent to about eighty five percent of a melt temperature of an aluminum alloy.

18. The method of claim 15, wherein the blank is heated while being formed.

19. The method of claim 15, further comprising:
annealing the drawn metal sheet after forming.

20. The method of claim 15, wherein the one or more stiffening features include one or more crossbars, and wherein the method further comprises:
joining a reinforcement member to an upper surface of a corresponding crossbar.
